(19) United States
(12) Patent Application Publication
(10) Pub. No.: US 2024/0383248 A1
(43) Pub. Date: Nov. 21, 2024

(54) APPARATUS AND METHOD FOR OPTIMALLY AND ADAPTIVELY CONTROLLING DISCHARGE OF INKJET PRINTING DROPLETS BY REINFORCEMENT LEARNING

(71) Applicant: POSTECH RESEARCH AND BUSINESS DEVELOPMENT FOUNDATION, Pohang-si (KR)

(72) Inventors: Sung June JUNG, Pohang-si (KR); Seong Ju KIM, Seoul (KR)

(21) Appl. No.: 18/569,281

(22) PCT Filed: Jun. 22, 2022
(86) PCT No.: PCT/KR2022/008847

§ 371 Date: Dec. 12, 2023

(30) Foreign Application Priority Data
Sep. 16, 2021 (KR) 10-2021-0123696

(51) Int. Cl. B41J 2/045; G06N 3/092; G06T 7/00

(52) U.S. Cl. CPC B41J 2/04588; B41J 2/04581; G06N 3/092; G06T 7/0004; G06T 2207/20081; G06T 2207/30144

(57) ABSTRACT

Provided are an apparatus and method for performing adaptive control to optimally control a driving waveform by reinforcement learning to discharge ideal droplets for inkjet printing and to maintain the discharging of the ideal droplets by adjusting the driving waveform according to a change in discharged droplets. It is possible to optimally and adaptively control the discharge of droplets on the basis of reinforcement learning technology for performing self-learning to receive as many positive rewards as possible by observing discharged droplets through a droplet discharge monitoring system and repeatedly performing learning for giving a positive or negative reward according to a droplet discharge state.

### TECHNICAL FIELD

The present disclosure relates to inkjet printing, and more particularly, to controlling a waveform for discharging droplets optimal for an inkjet printing process.

### BACKGROUND ART

The contents described herein are intended to merely provide background information of embodiments set forth herein and should not be understood as necessarily constituting the related art.

A basic operating principle of an inkjet printer is to fill an ink chamber, which is equipped with nozzles that are thin tubes, with ink and generate pressure in the ink chamber for a short period of time to spray ink droplets through the nozzles.

Inkjet printers may be largely classified according to a piezoelectric method and a thermal method. In the piezoelectric method, ink is sprayed through compression and expansion as the vibrational motion of a piezoelectric material attached inside an ink chamber with nozzles acts as an actuator. On the other hand, in the thermal method, ink is sprayed as bubbles instantaneously generated by supplying electric power to a thin-film heater with resistance acts as an actuator.

The range of application of piezoelectric inkjet printers is gradually expanding from office printers to industrial printers and tools for manufacturing processes. In this case, as a driving voltage pulse of an inkjet printer head is a signal directly applied to a piezoelectric element, a voltage and a time the voltage is applied may greatly affect the size and discharge rate of ink dots to be discharged.

Ink droplets are sprayed from the piezoelectric inkjet head according to a driving voltage pulse signal applied to the piezoelectric element, and in this case, because the driving voltage pulse is a signal directly applied to the piezoelectric element, a voltage and a time the voltage is applied may affect discharge characteristics of ink droplets, i.e., a dot size and injection rate of ink to be sprayed.

The inkjet process allows fine droplets to be deposited at a desired location and is very economical in terms of a solution process and thus has drawn much attention in various fields. However, there are limitations in terms of ink to be used, difficulties in setting droplet discharge characteristics, and the like.

In particular, droplet discharge characteristics are determined by various factors such as the fluid properties of ink, a driving waveform, and nozzle characteristics but the driving waveform is easiest to adjust. In general, the droplet discharge characteristics are checked and the driving waveform is detected by changing elements of the driving waveform while actually discharging droplets.

Even when nozzles have the same structure, there is a difference in droplet discharge characteristics between the nozzles according to the driving waveform. In actual industry, more than 100 nozzles are used and there is a limitation in applying a general driving waveform design method for each nozzle.

Research has been conducted on optimal driving waveforms in many ways. For example, a method of designing an optimal driving waveform by observing the movement of a meniscus during the discharge of droplets was proposed (Non-patent Document 1 among the Related Art Literature). However, an optimal driving waveform may vary according to the properties of ink and nozzles, and it is unclear whether this method is applicable to functional ink for use in actual industry. Thus, as a solution to the above problem, the use of feedback has been considered in many cases. Methods of adjusting elements of the driving waveform through feedback according to characteristics of discharged droplets have been used. However, in this case, the correlation between droplet discharge characteristics and driving waveform elements should be understood to receive feedback, and it is difficult to handle situations such as a failure of nozzles and changes in ink.

A study on predicting droplet discharge characteristics using machine learning has also been recently reported (Non-patent Document 2 among the Related Art Literature). However, in this study, elements of a driving waveform were dealt with very narrowly and droplet discharge characteristics were simply predicted. A study on improving droplet discharge characteristics by machine learning has also been reported (Non-patent Document 3 among the Related Art Literature). However, complexity was increased by reflecting the adjustment of the fluid properties of ink in optimization conditions.

### RELATED ART LITERATURE

### Non-Patent Documents

(Non-patent Document 1) [1] Ky-Si Kwon. Waveform Design Methods for Piezo Inkjet Dispensers Based on Measured Meniscus Motion. J. Microelectromechanical Syst. 18, 1118-1125 (2009).
(Non-patent Document 2) [2] Wu, D. & Xu, C. Predictive Modeling of Droplet Formation Processes in Inkjet-Based Bioprinting. J. Manuf. Sci. Eng. 140, 101007 (2018).
(Non-patent Document 3) [3] 1. Shi, J., Song, J., Song, B. & Lu, W. F. Multi-Objective Optimization Design through Machine Learning for Drop-on-Demand Bioprinting. Engineering 5, 586-593 (2019).

### DISCLOSURE

### Technical Problem

The present disclosure is directed to providing an apparatus and method for adaptively controlling a driving waveform for the discharge of ideal inkjet printing droplets by reinforcement learning.

The present disclosure is not limited thereto and aspects thereof that are not described above will be apparent to those of ordinary skill in the art from the following description.

### Technical Solution

An aspect of the present disclosure provides an apparatus for adjusting an inkjet printing driving waveform, the apparatus including a driving waveform generator configured to generate various driving waveforms to be applied to a piezoelectric material attached to an ink chamber; a piezoelectric material driver configured to drive the piezoelectric material according to a driving waveform output from the driving waveform generator; an imaging unit configured to image droplets discharged from nozzles attached to one end of the ink chamber; a training data storage configured to map and store each driving waveform generated by the driving waveform generator and data of the droplets imaged by the imaging unit; a droplet discharge characteristic extractor configured to extract droplet discharge characteristics from the data of the imaged droplets, and map information about the extracted droplet discharge characteristics to a corresponding driving waveform and store a mapping result in the training data storage; a reward score evaluator configured to receive desired droplet discharge characteristic information and give a higher score to a driving waveform closer to the received desired droplet discharge characteristic information among the information about the extracted droplet discharge characteristics; and a reinforcement learning part configured to control either a driving waveform generated by the driving waveform generator or a driving waveform to which a highest reward score is given to be output to the piezoelectric material driver.

According to an embodiment of the present disclosure, the droplet discharge characteristic extractor may extract information about a speed or total number of droplets.

Preferably, the droplet discharge characteristic extractor may extract the information about the speed of the droplets divided into an X-axis speed of the droplets and a Y-axis speed of the droplets, and extract information about a distance from an end of the nozzles to an outermost protruding portion of the droplets when the total number of the droplets is zero.

According to an embodiment of the present disclosure, information about fluid properties of ink or a geometric structure of the nozzles may be further mapped and stored in the training data storage. The information about the fluid properties of the ink may include information about at least one of viscosity, density, or surface tension.

An aspect of the present disclosure provides a method of adjusting an inkjet printing driving waveform by an apparatus that includes a driving waveform generator, a piezoelectric material driver, an imaging unit, a training data storage, a droplet discharge characteristic extractor, a reward score evaluator, and a reinforcement learning part, the method including (a) generating, by the driving waveform generator, various driving waveforms to be applied to a piezoelectric material attached to an ink chamber; (b) driving, by the piezoelectric material driver, the piezoelectric material according to the driving waveforms output from the driving waveform generator; (c) imaging, by the imaging unit, droplets discharged from nozzles attached to one end of the ink chamber; (d) mapping and storing, by the training data storage, each driving waveform generated by the driving waveform generator and data of the droplets imaged by the imaging unit; (e) extracting, by the droplet discharge characteristic extractor, droplet discharge characteristics from the data of the imaged droplets and mapping information about the extracted droplet discharge characteristics to a corresponding driving waveform and storing a mapping result in the training data storage; (f) receiving, by the reward score evaluator, desired droplet discharge characteristic information and giving a higher score to a driving waveform closer to the received desired droplet discharge characteristic information among the information about the extracted droplet discharge characteristics; (g) controlling, by the reinforcement learning part, either a driving waveform generated by the driving waveform generator or a driving waveform to which a highest score is given by the reward score evaluator to be output to the piezoelectric material driver, and (h) repeatedly performing (c) to (g) a predetermined number of times.

In an embodiment of the present disclosure, (d) may include extracting information about a speed or total number of droplets by the droplet discharge characteristic extractor.

Preferably, the droplet discharge characteristic extractor may extract the information about the speed of the droplets divided into an X-axis speed of the droplets and a Y-axis speed of the droplets, and extract information about a distance from an end of the nozzles to an outermost protruding portion of the droplets when the total number of the droplets is zero.

According to an embodiment of the present disclosure, information about fluid properties of ink or a geometric structure of the nozzles may be further mapped and stored by the training data storage. The information about the fluid properties of the ink may include information about at least one of viscosity, density, and surface tension.

The method of adjusting an inkjet printing driving waveform according to the present disclosure may be implemented in the form of a computer program written to perform operations included in the method and recorded on a computer-readable recording medium.

Other aspects of the present disclosure will be apparent from the detailed description and drawings.

### Advantageous Effects

According to an aspect of the present disclosure, it is possible to automate the optimization of an inkjet printing driving waveform and respond to changes in droplet discharge.

According to another aspect of the present disclosure, in the case of inkjet printing, it is possible to respond to changes in process conditions such as a temperature increase due to the speed of a high-frequency process and a change in droplet discharge due to particles in ink.

Effects of the present disclosure are not limited thereto and other effects that are not described herein will be apparent to those of ordinary skill in the art from the following description.

### DESCRIPTION OF DRAWINGS

FIG. 1 is a schematic block diagram of a configuration of an apparatus for adjusting an inkjet printing driving waveform according to the present disclosure.

FIG. 2 is a flowchart of a method of adjusting an inkjet printing driving waveform according to the present disclosure.

FIG. 3 is a reference diagram of a process of detecting an optimal inkjet printing driving waveform according to a method according to the present disclosure.

FIG. 4 illustrates a shape of a driving waveform applied to an inkjet printing nozzle.

FIG. 5 illustrates a process in which the speed and total number of droplets change as a driving waveform changes.

FIG. 6 is a schematic diagram illustrating an example of handling a change in droplet discharge according to an apparatus and method of the present disclosure.

### MODES OF THE INVENTION

Advantages and features of the present disclosure and methods of achieving them will be apparent from embodiments of the disclosure described in detail, in conjunction with the accompanying drawings. However, the present disclosure is not limited to the embodiments set forth herein and may be embodied in many different forms. The embodiments are merely provided so that this disclosure will be thorough and complete and will fully convey the scope of the present disclosure to those of ordinary skill to which the present disclosure pertains (hereinafter, “those of ordinary skill in the art”). The scope of the present disclosure is only defined by the claims.

Terms used herein are for the purpose of only describing embodiments and are not intended to limit the present disclosure. As used herein, singular forms are intended to include plural forms unless the context clearly indicates otherwise. As used herein, the terms “comprise” and/or “comprising” specify the presence of stated components but do not preclude the presence or addition of one or more other components.

Throughout the disclosure, like reference numerals refer to like elements, and “and/or” includes each and all combinations of one or more of the mentioned components. Although “first,” “second,” etc. are used to describe various components, these components are not limited by these terms. These terms are only used to distinguish one component from another. Therefore, a first component discussed below could be termed a second component without departing from the technical scope of the present disclosure.

Unless otherwise defined, all terms (including technical and scientific terms) used herein have the same meaning as commonly understood by those of ordinary skill in the art to the present disclosure pertains. Terms, such as those defined in commonly used dictionaries, will not be interpreted in an idealized or overly formal sense unless expressly so defined herein. Hereinafter, embodiments of the present disclosure will be described in detail with reference to the accompanying drawings.

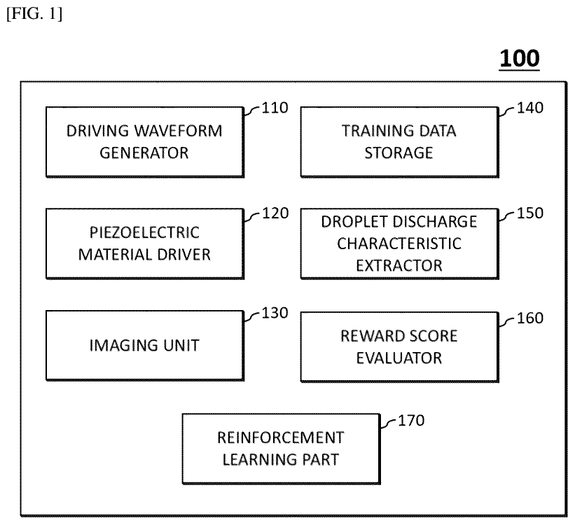

FIG. 1 is a schematic block diagram of a configuration of an apparatus for adjusting an inkjet printing driving waveform according to the present disclosure.

Referring to FIG. 1, an inkjet printing driving waveform adjusting apparatus 100 according to the present disclosure may include a driving waveform generator 110, a piezoelectric material driver 120, an imaging unit 130, a training data storage 140, a droplet discharge characteristic extractor 150, a reward score evaluator 160, and a reinforcement learning part 170.

The driving waveform generator 110 may generate various driving waveforms to be applied to a piezoelectric material attached to an ink chamber. The ink chamber has a space for accommodating ink to be used in an inkjet printer. Nozzles through which ink is sprayed are attached to one end of the ink chamber, and a piezoelectric material is attached to the ink chamber. When a voltage is applied to the piezoelectric material, vibrations may be generated and the vibrational motion of the piezoelectric material may act as an actuator and the ink contained in the ink chamber is compressed and/or expanded and sprayed through the nozzles. In this case, a state of the ink droplets sprayed through the nozzles may vary according to the voltage applied to the piezoelectric material, i.e., the characteristics of a driving waveform. The driving waveform may be generated according to various variables such as a maximum voltage, a voltage increase time, a maximum voltage retention time, and a voltage decrease time. Accordingly, the driving waveform generator 110 may generate various driving waveforms by changing at least one of the maximum voltage, the voltage increase time, the maximum voltage maintenance time, or the voltage decrease time.

The piezoelectric material driver 120 may drive the piezoelectric material according to the driving waveforms output from the driving waveform generator 110. To this end, the piezoelectric material driver 120 may include a power supply device that generates a voltage corresponding to the driving waveform output from the driving waveform generator 110.

The imaging unit 130 may image droplets discharged from the nozzles attached to one end of the ink chamber. The imaging unit 130 may include a camera and a light source to image the discharged droplets. For example, the camera and the light source may be disposed in opposite directions while the nozzles are disposed therebetween. Therefore, in this case, when discharged droplets are imaged by the camera, the droplets may be imaged against light to be distinguished more clearly from the surrounding environment. In addition, the camera may be a high-speed camera for imaging the characteristics of discharged droplets in more detail over time.

The training data storage 140 may store data of the droplets imaged by the imaging unit 130. In this case, because the droplets imaged by the imaging unit 130 may vary according to various driving waveforms generated by the driving waveform generator 110, the data and each driving waveform generated by the driving waveform generator 110 may be mapped to each other and stored.

The droplet discharge characteristic extractor 150 may extract droplet discharge characteristics from the imaged droplet. In the present specification, the droplet discharge characteristics should be understood to mean a falling speed of droplets or the number of discharged droplets. Therefore, the droplet discharge characteristic extractor 150 may extract information about the speed or total number of droplets from the data of the imaged droplet using an image reading algorithm or the like. Specifically, the droplet discharge characteristic extractor 150 may extract information about the speed of the droplets divided into an X-axis speed of the droplets and a Y-axis speed of the droplets, and extract information about a distance from the end of the nozzles to an outermost protruding portion of the droplets when the number of droplets is zero. For reference, the X-axis of the droplets may be a horizontal axis and the Y-axis of the droplets may be a vertical axis (in the direction of gravity) in the data. In addition, the droplet discharge characteristic extractor 150 may map information about the extracted droplet discharge characteristics to a corresponding driving waveform and store a mapping result in the training data storage 140.

Desired droplet discharge characteristic information may be input to the reward score evaluator 160. For example, a desired optimal droplet discharge characteristic may be a single droplet with a speed of 4 m/s. The reward score evaluator 160 may give a higher score to a driving waveform closer to the input desired droplet discharge characteristic information among the information about the extracted droplet discharge characteristics.

The reinforcement learning part 170 may control either a driving waveform generated by the driving waveform generator 110 or a driving waveform to which the highest reward score is given by the reward score evaluator 160 to be output to the piezoelectric material driver 120.

Meanwhile, there may be factors that may affect the droplet discharge characteristics, as well as the driving waveform. The droplet discharge characteristics may also be affected by the fluid properties of ink and/or the geometric structure of the nozzles. Therefore, when various models for droplet discharge characteristics are generated, more accurate predictive models can be generated by taking into account the fluid properties of ink, geometric driving of nozzles, and an operating method of the nozzles.

According to an embodiment of the present disclosure, information about the fluid properties of the ink or the geometric structure of the nozzles may further be mapped and stored in the training data storage 140. For example, the information about the fluid properties of the ink may include at least one of viscosity, density, and surface tension.

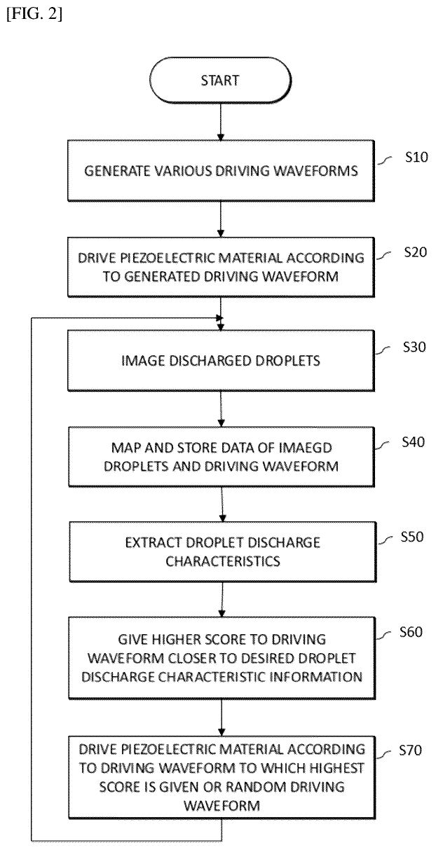

A method of adjusting an inkjet printing driving waveform according to the present disclosure will be described with reference to FIG. 2 below. However, in describing the method of adjusting an inkjet printing driving waveform according to the present disclosure, the inkjet printing driving waveform adjusting apparatus 100 according to the present disclosure is used in the method and thus a description thereof is not redundantly described herein.

FIG. 2 is a flowchart of a method of adjusting an inkjet printing driving waveform according to the present disclosure.

First, in operation S10, the driving waveform generator 110 may generate various driving waveforms to be applied to a piezoelectric material attached to an ink chamber. In operation S20, the piezoelectric material driver may drive the piezoelectric material according to a driving waveform output from the driving waveform generator. In operation S30, the imaging unit 130 may image droplets discharged from nozzles attached to one end of the ink chamber. In operation S40, data of the droplets imaged by the imaging unit may be mapped to each driving waveform generated by the driving waveform generator, and a mapped result may be stored in the training data storage. According to an embodiment of the present disclosure, in operation S40, information about fluid properties of ink or a geometric structure of the nozzles may further be mapped and stored in the training data storage. In this case, the information about the fluid properties of the ink may include information about at least one of viscosity, density, or surface tension. In operation S50, the droplet discharge characteristic extractor 150 may extract droplet discharge characteristics from the data of the imaged droplets, map information about the extracted droplet discharge characteristics to a corresponding driving waveform, and store a mapping result in the training data storage 140. In operation S60, the reward score evaluator 160 may receive desired droplet discharge characteristic information and give a higher score to a driving waveform closer to the received droplet discharge characteristic information among the information about the extracted droplet discharge characteristics. In operation S70, the reinforcement learning part 170 may control either a driving waveform generated by the driving waveform generator 110 or a driving waveform to which the highest reward score is given by the reward score evaluator 160 to be output to the piezoelectric material driver. Operations S30 to S70 may be repeatedly performed a predetermined number of times (e.g., 10⁵ times).

The selection of one of two waveforms by the reinforcement learning part 170 may occur stochastically. For example, when an arbitrary variable is set to 0.5, a waveform to which the highest reward score is given may be selected when a random number generated by a program is greater than 0.5, and a driving waveform randomly generated by the driving waveform generator may be selected when the random number is equal to or less than 0.5. In this case, the arbitrary variable of 0.5 may be changed according to a situation or an application. Meanwhile, the driving waveform generator may generate a waveform by randomly selecting and combining previously generated waveforms or waveforms to which a reward score is given. For example, a new driving waveform may be generated by combining a waveform to which the highest reward score is given and an arbitrarily generated waveform.

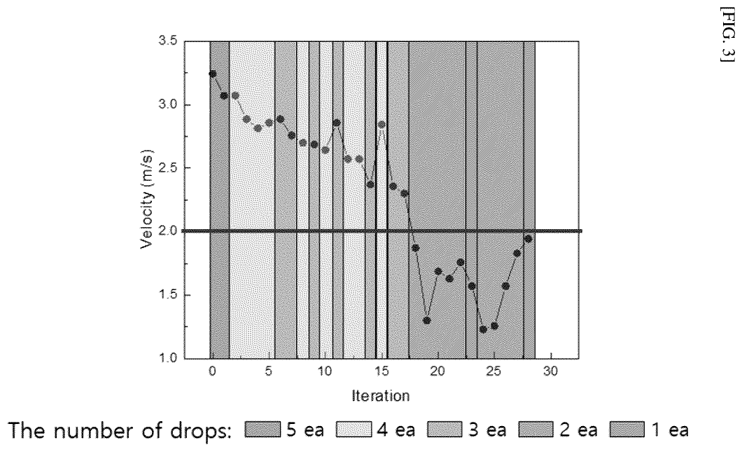

FIG. 3 is a reference diagram of a process of detecting an optimal inkjet printing driving waveform according to a method according to the present disclosure.

In an example of FIG. 3, a desired droplet discharge characteristic was set such that one droplet was discharged at 2 m/s. It can be seen that the number of discharged droplets decreased from five to four, three, two, and finally, to one. In addition, it can be seen that a discharge speed of droplets gradually decreased from about 3.5 m/s to 0.5 m/s and thereafter increased to 2 m/s. That is, it can be seen that as the number of iterations increases, the goal of “discharging one droplet at 2 m/s” is closer.

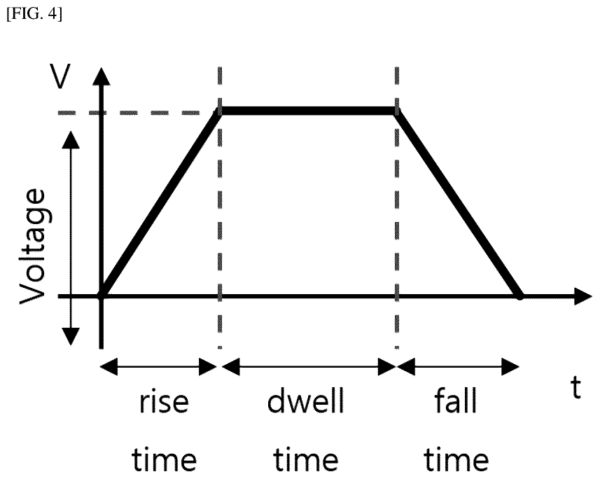

FIG. 4 illustrates a shape of a driving waveform applied to an inkjet printing nozzle.

Referring to FIG. 4, “Rise time” denotes the time during which a piezo-actuator inside a nozzle expands, “dwell time” denotes the time during which the expansion of the piezo-actuator remains, and “fall time” denotes the time it takes for the piezo-actuator to contract again. The degree to which the piezo-actuator contracts or expands is influenced by voltage.

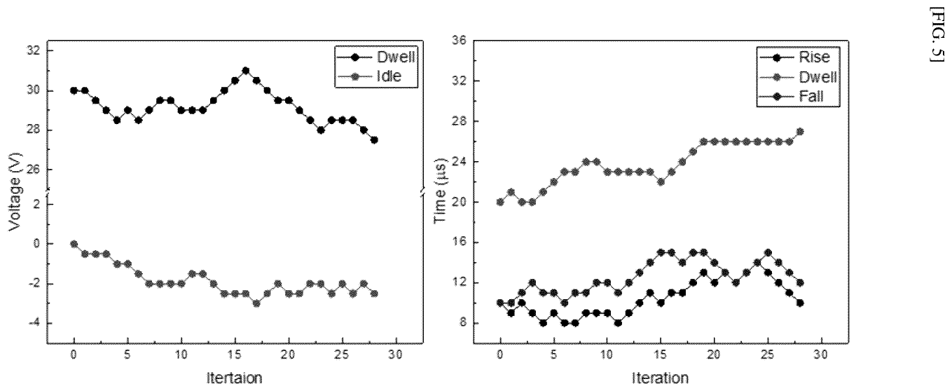

FIG. 5 illustrates a process in which the speed and total number of droplets change as a driving waveform changes.

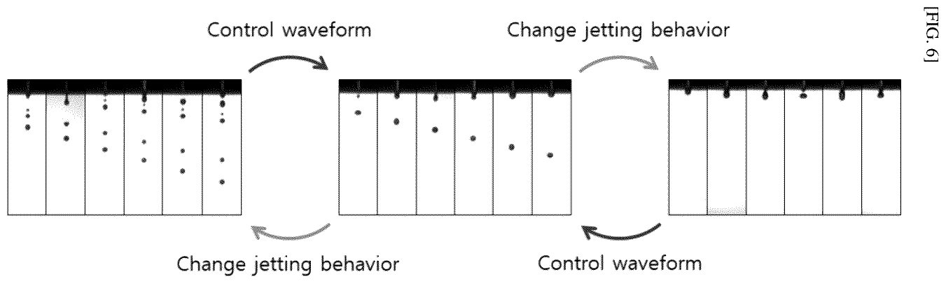

FIG. 6 is a schematic diagram illustrating an example of handling a change in droplet discharge according to an apparatus and method of the present disclosure.

Meanwhile, the driving waveform generator 110, the training data storage 140, the droplet discharge characteristic extractor 150, the reward score evaluator 160, and the reinforcement learning part 170 may include a processor, an application-specific integrated circuit (ASIC), another chipset, a logic circuit, a register, a communication modem, a data processing device, and the like, which are known in the technical field to which the present disclosure pertains, to execute various logics as described above. When the above-described control logic is implemented by software, the above elements may be implemented as a set of program modules. In this case, the program modules may be stored in the memory device and executed by the processor.

The computer program may include code written in a computer language, such as C/C++, C#, JAVA, Python, or machine language, which is readable by a processor (CPU) of the computer through a device interface of the computer, to allow the computer to read the computer program and execute the methods implemented as the computer program. The code may include functional code related to functions that define functions necessary to execute the methods and control code related to an execution procedure necessary for the processor of the computer to execute the functions according to the execution procedure. The code may further include additional information necessary for the processor of the computer to execute the functions or memory-reference-related code indicating a location (address) in the computer or on an external memory to be referenced by media. When there is a need for the processor of the computer to communicate with another computer or a server at a remote place so as to execute the functions, the code may further include communication-related code indicating how to communicate with another computer or a server at a remote place using a communication module of the computer, information or media to be transmitted or received during communication, and the like.

The medium in which the program is stored should be understood to mean a medium, e.g., a register, a cache, or a memory, that does not store data for a short time but stores data semi-permanently and that is readable by devices. Specifically, examples of the medium include a ROM, a RAM, a CD-ROM, a magnetic tape, a floppy disk, an optical data storage device, etc. but are not limited thereto. That is, the program may be stored in various types of recording media on various types of servers accessible by the computer or various types of recording medium on the computer of a user. In addition, the medium may be distributed to computer systems connected via a network and store code readable by computers in a distributed method.

While embodiments of the present disclosure have been described above with reference to the accompanying drawings, it will be obvious to those of ordinary skill in the art that the present disclosure may be embodied in many different forms without departing from the technical spirit or essential features thereof. Therefore, it should be understood that the embodiments described above are provided to give examples in all aspects and are not for purposes of limitation.

### REFERENCE NUMERALS

100: inkjet printing driving waveform adjustment apparatus
110: driving waveform generator
120: piezoelectric material driver
130: imaging unit
140: training data storage
150: droplet discharge characteristic extractor
160: reward score evaluator
170: reinforcement learning part

1. An apparatus for adjusting an inkjet printing driving waveform, comprising:
a driving waveform generator configured to generate various driving waveforms to be applied to a piezoelectric material attached to an ink chamber;
a piezoelectric material driver configured to drive the piezoelectric material according to a driving waveform output from the driving waveform generator;
an imaging unit configured to image droplets discharged from nozzles attached to one end of the ink chamber;
a training data storage configured to map and store each driving waveform generated by the driving waveform generator and data of the droplets imaged by the imaging unit;
a droplet discharge characteristic extractor configured to extract droplet discharge characteristics from the data of the imaged droplets, map information about the extracted droplet discharge characteristics to a corresponding driving waveform, and store a mapping result in the training data storage;
a reward score evaluator configured to receive desired droplet discharge characteristic information and give a higher score to a driving waveform closer to the received desired droplet discharge characteristic information among the information about the extracted droplet discharge characteristics; and
a reinforcement learning part configured to control either a driving waveform generated by the driving waveform generator or a driving waveform to which a highest reward score is given to be output to the piezoelectric material driver.

2. The apparatus of claim 1, wherein the droplet discharge characteristic extractor extracts information about a speed or total number of droplets.

3. The apparatus of claim 2, wherein the droplet discharge characteristic extractor extracts the information about the speed of the droplets divided into an X-axis speed of the droplets and a Y-axis speed of the droplets, and extracts information about a distance from an end of the nozzles to an outermost protruding portion of the droplets when the total number of the droplets is zero.

4. The apparatus of claim 1, wherein information about fluid properties of ink or a geometric structure of the nozzles are further mapped and stored in the training data storage.

5. The apparatus of claim 4, wherein the information about the fluid properties of the ink comprises information about at least one of viscosity, density, and surface tension.

6. A method of adjusting an inkjet printing driving waveform by an apparatus that includes a driving waveform generator, a piezoelectric material driver, an imaging unit, a training data storage, a droplet discharge characteristic extractor, a reward score evaluator, and a reinforcement learning part, the method comprising:
(a) generating, by the driving waveform generator, various driving waveforms to be applied to a piezoelectric material attached to an ink chamber;
(b) driving, by the piezoelectric material driver, the piezoelectric material according to a driving waveform output from the driving waveform generator;
(c) imaging, by the imaging unit, droplets discharged from nozzles attached to one end of the ink chamber;
(d) mapping and storing, by the training data storage, each driving waveform generated by the driving waveform generator and data of the droplets imaged by the imaging unit;
(e) extracting, by the droplet discharge characteristic extractor, droplet discharge characteristics from the data of the imaged droplets and mapping information about the extracted droplet discharge characteristics to a corresponding driving waveform and storing mapping results in the training data storage;
(f) receiving, by the reward score evaluator, desired droplet discharge characteristic information and giving a higher score to a driving waveform closer to the received desired droplet discharge characteristic information among the information about the extracted droplet discharge characteristics;
(g) controlling, by the reinforcement learning part, either a driving waveform generated by the driving waveform generator or a driving waveform to which a highest reward score is given by the reward score evaluator to be output to the piezoelectric material driver; and
(h) repeatedly performing (c) to (g) a predetermined number of times.

7. The method of claim 6, wherein (e) comprises extracting information about a speed or total number of droplets by the droplet discharge characteristic extractor.

8. The method of claim 7, wherein the droplet discharge characteristic extractor extracts the information about the speed of the droplets divided into an X-axis speed of the droplets and a Y-axis speed of the droplets, and extracts information about a distance from an end of the nozzles to an outermost protruding portion of the droplets when the total number of the droplets is zero.

9. The method of claim 6, further comprising mapping and storing, by the training data storage, information about fluid properties of ink or a geometric structure of the nozzles in the training data storage.

10. The method of claim 9, wherein the information about the fluid properties of the ink comprises information about at least one of viscosity, density, or surface tension.

11. A computer program causing a computer to execute operations of the method of adjusting an inkjet printing driving waveform of any one of claims 6 to 10, and recorded on a computer-readable recording medium.
